(19) United States
(12) Patent Application Publication
(10) Pub. No.: US 2012/0145550 A1
(43) Pub. Date: Jun. 14, 2012

(54) APPARATUS FOR REMOVING IONS IN COOLING WATER FOR FUEL CELL VEHICLE

(75) Inventors: Chi Myung Kim, Yongin (KR); Gi Young Nam, Yongin (KR); Seong Kyun Kim, Seoul (KR)

(73) Assignee: HYUNDAI MOTOR COMPANY, Seoul (KR)

(21) Appl. No.: 13/169,494

(22) Filed: Jun. 27, 2011

(30) Foreign Application Priority Data
Dec. 9, 2010 (KR) 10-2010-0125822

(51) Int. Cl. B01D 61/54; H01M 2/40; H01M 8/04; B01D 61/46

(52) U.S. Cl. 204/628; 204/633

(57) ABSTRACT

Disclosed is an apparatus for efficiently removing ions contained cooling water used in cooling a fuel cell stack. More specifically, the present invention removes ions by trapping ions contained in cooling water using a permeable membranes capable of making ions selectively pass therethrough and electrodes which are configured to attract ions. The present invention can reduce electric power consumption in pump and can modify the overall performance of the system to cope with various environmental conditions.

### CROSS-REFERENCE TO RELATED APPLICATION

This application claims under 35 U.S.C. §119(a) the benefit of Korean Patent Application No. 10-2010-0125822 filed Dec. 9, 2010, the entire contents of which are incorporated herein by reference.

### BACKGROUND

(a) Technical Field

The present invention relates to an apparatus for removing ions from cooling water in a fuel cell stack of a fuel cell vehicle. More particularly, it relates to an apparatus for efficiently removing ions contained in cooling water in a fuel cell stack of a fuel cell vehicle.

(b) Background Art

Generally, a fuel cell system used as a power source of a fuel cell vehicle is supplied with fuels containing hydrogen and oxidizing agents containing oxygen. It then separates hydrogen ions from the fuels through a catalytic reaction in a cathode, and transfers them to an anode, thereby moving electrons through a wire connected to the opposite side to thereby generate electric power.

Since such fuel cell system needs a large output capacity, the system is commonly formed of a fuel cell stack in which a dozen to hundreds of fuel cell units are stacked as a constituent unit. The reaction in the fuel cell generates electric power, and, at the same time, creates water. Incidentally, in the case of polymer electrolyte membranes, the membrane can be melted at temperatures higher than an optimum temperature, or cause a decrease in hydrogen-ion transferring performance due to water evaporation. If this occurs, the polymer electrolyte membrane is and could cause the entire system to power-down (i.e., cause a decrease in the overall voltage output).

In a fuel cell system, water created at the time of reaction cannot be vaporized below an optimum temperature of the fuel cell stack, and the excessive amount of which is condensed and remains in a liquid phase. This results in clogging of a cathode channel thereof and also obscures the oxygen supply, and thus could cause the entire system to power-down. Accordingly, it is essential to maintain an optimum temperature for the efficient reaction of a fuel cell.

For this reason, a conventional fuel cell system is provided with a cooling water circulation loop in which a common pump circulates cooling water through the fuel cell stack, and is mounted therein with a cooler to maintain an optimum temperature thereof. However, since cooling water flows through bipolar plates having different voltages, in the case of the cooling water which has an electrical conductivity, electricity generated flows partly through the conductive cooling water, thereby consuming some amount of energy.

Also, in a case where cooling water has a high electrical conductivity, the electrical insulation characteristics within a vehicle may be deteriorated thereby infringing criteria for passengers' safety. Accordingly, it is necessary to control the electrical conductivity of cooling water.

In this regard, a conventional system discloses manufacturing of an ion removing apparatus in a manner of being filled therein with an ion exchange resin capable of capturing ions which is mounted on a cooling water line (see Korean Patent Application Nos. 10-2008-0013354 and 10-2010-0072409).

However, such an ion removing apparatus formed of a resin type filler allows an excessive pressure differential to be applied to cooling water, and, thus, it is difficult to connect the apparatus directly to a main pipe. Accordingly, the apparatus should be connected mainly to a branch pipe line, thereby increasing the electric power consumption in a pump for an additional production of discharge, and increasing the time to reduce an electrical conductivity of the whole cooling water to an optimum level because only a part of the whole amount of discharge flows through the ion removing apparatus.

In addition, the above art is a disadvantage in that it is impossible to intentionally change the performance of the ion removing process in response to an environment thereof because the performance of the ion removing process is determined according to a resin state thereof.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to an apparatus for removing ions contained in cooling water of a fuel cell vehicle by trapping ions contained in cooling water using a permeable membrane and ion-attracting electrodes where the permeable membrane allows ions to selectively pass through, thereby reducing electric power consumption in a pump while changing the performance of the ion removing process in response to various environmental conditions.

In one aspect the present invention provides a cooling water ion removing apparatus for a fuel cell vehicle including a housing mounted on an inlet side line of a fuel cell stack to form a channel through which cooling water passes and a plurality of anion permeable membranes and cation permeable membranes. Each of the plurality of anion permeable membranes and cation permeable membranes are respectively mounted on both sides of cooling water channel formed in the housing to allow cations and anions contained in cooling water to selectively pass through. Furthermore, the present invention also include one or more concentrate capturing members respectively disposed at each rear side of the anion permeable membranes and the cation permeable membranes to capture anions and cations having passed through the permeable membranes. Disposed at each rear side of the concentrate capturing members are at least two or more electrodes which are configured to attract anions and cations contained in cooling water, respectively. In addition, the present invention may also include a controller for controlling the electrodes, and a power source for applying electric power, thereby lowering the electrical conductivity of cooling water to an optimum level by applying a direct current power supply and attracting cations and anions contained in cooling water to remove the ions.

Advantageously, unlike the conventional ion removing apparatus formed by being filled with an ion exchange resin, the amount of consumed electricity is not as great because electric current seldom flows through the cooling water and the ion removing apparatus may be mounted to a main pipe because hydraulic resistance is also low, thereby the consumption of electric power is reduced as a flow rate necessary for branching of a pipe and power consumption of pump is accordingly reduced as well.

Additionally, in a case when a main pipe is mounted, the number of piping and brackets necessary for branching the pipe may be reduced, and power consumption of pump is also reduced even when a pipe branch is used as well.

Third, since the ion removing apparatus according to the present invention can change the performance e of the ion removing process in response to an environmental change the ion removing apparatus can enhance the performance of the ion removing process abruptly, thereby responding to a changeable environment. This is true even when a flow rate flowing into a cooler abruptly increases and the electrical conductivity at an inlet of the fuel cell stack also abruptly increases.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an apparatus for removing ions in cooling water for a fuel cell vehicle according to an exemplary embodiment of the invention;

FIG. 2 is a cross sectional view showing an electrodialysis type of ion removing apparatus associated with an apparatus for removing ions contained in cooling water for a fuel cell vehicle according to an exemplary embodiment of the invention; and

FIG. 3 is a cross sectional view showing an operation state of the electrodialysis type of ion removing apparatus associated with the apparatus for removing ions contained in cooling water according to an exemplary embodiment of the present invention.

Reference numerals set forth in the Drawings includes reference to the following elements as further discussed below:
10: housing
11: anion permeable membrane
12: cation permeable membrane
13a, 13b: concentrate capturing member
14: electrode
15: controller
16: electric power source
17: electrical conductivity sensor
18: valve
19: discharge line
100: fuel cell stack
110: reservoir
120: pump
130: cooler
140: valve

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

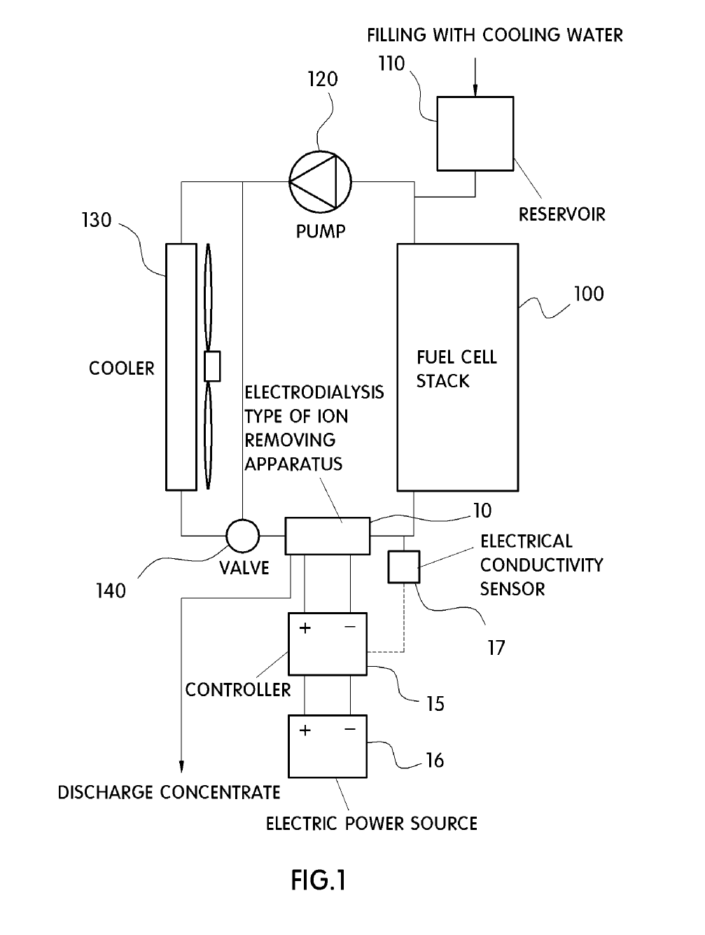

FIG. 1 is a schematic diagram showing an apparatus for removing ions in cooling water for a fuel cell vehicle according to an exemplary embodiment of the invention.

As shown in FIG. 1, the apparatus for removing ion in cooling water is configured to electrically trap ions contained in cooling water by using a permeable membrane for selective permeation of ions and electrodes of electrically attracting ions.

To obtain such performance, the apparatus is provided with a housing 10 which is formed therein with a flow channel containing cooling water, and the housing 10 is disposed on a cooling water flowing line in parallel with a fuel cell stack 100. That is, the housing 10 is mounted at an inlet side line of the fuel cell stack 100 on a cooling water circulation line formed between the fuel cell stack 100 and the cooler 130, and is configured to trap ions contained in the cooling water supplied to the fuel cell stack 100.

Also, the housing 10 is connected to the controller 15 and the electric power source 16, so that the controller 15 and the electric power source 16 serve to apply electric power to electrodes (not shown) mounted in the housing 10 and to control the electric power therein.

More particularly, the electrical conductivity sensor 17 is mounted at one side of the cooling water line extended from an outlet end of the housing 10, for example, at a front region of an inlet side line of the fuel cell stack 100, and the mounted electrical conductivity sensor 17 serves to measure an electrical conductivity of cooling water flowing along the cooling water line to provide the controller 15 with the measured data.

Accordingly, the cooling water circulating for cooling of the fuel cell stack 100 passes through the housing 10 mounted on the inlet side line of the fuel cell stack 100. That is, the cooling water before it enters the fuel cell stack passes through the apparatus for removing ions in cooling water. In this way, ions contained in cooling water are removed in an electrodialysis fashion by circulating/passing the cooling water through the apparatus before it enters the fuel cell apparatus, thereby resulting in a lower electrical conductivity of the cooling water thus preventing energy loss caused by the cooling water having a high electrical conductivity.

Herein, unexplained numeral “110” indicates a reservoir, “120” indicates a pump, and “140” indicates a valve, respectively.

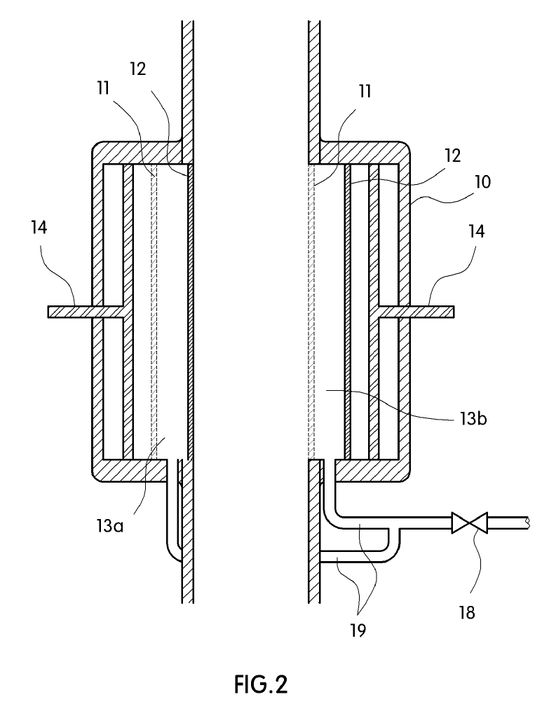

FIG. 2 is a cross sectional view showing an electrodialysis type of ion removing apparatus associated with an apparatus for removing ions contained in cooling water for a fuel cell vehicle according to an exemplary embodiment of the invention.

As shown in FIG. 2, the main body of the apparatus for removing ions in cooling water is formed of a housing 10, and the housing 10 is provided therein with a cooling water channel through which cooling water may flow along a central axis line thereof.

The housing 10 is mounted therein with an anion permeable membrane 11 and a cation permeable membrane 12. Accordingly, the anion permeable membrane 11 allows anions to selectively permeate its surface and the cation permeable membrane allows cations to selectively permeate its surface. More specifically, the anion permeable membranes 11 and the cation permeable membranes 12 are arrayed in a form of facing each other with the cooling water channel therebetween.

In this configuration, a plurality of the anion permeable membranes 11 and the cation permeable membranes 12 may be stacked closely to each other, or stacked at a predetermined interval therebetween. For example, the configuration may be formed in such manner that the cation permeable membrane 12 is disposed at one side in the housing 10 and the anion permeable membrane 11 is disposed at an opposite side in the housing 10, or a pair of the anion permeable membrane 11 and the cation permeable membrane 12 are disposed at one side therein and a anion permeable membrane 11 and cation permeable membrane 12 pair is disposed at an opposite side therein as well.

Herein, in a case where the anion permeable membrane 11 and cation permeable membrane 12 pair is disposed on both sides of the housing with the cooling water channel therebetween, the one pair is disposed so that the cation permeable membrane 12 may be in contact with the cooling water channel, while the other side pair is disposed so that the anion permeable membrane may be in contact with the cooling water channel. Accordingly, the anions among a plurality of ions contained in cooling water are gathered at one side through the anion permeable membrane 11, and the cations are gathered at the opposite side through the cation permeable membrane 12.

In addition, the housing 10 is provided therein with concentrate capturing members 13a, 13b which are capable of capturing cations or anions which have passed through each of the permeable membranes respectively.

Such concentrate capturing members 13a, 13b each are formed in a space occupying each rear side of the anion permeable membrane 11 and the cation permeable membrane 12, and may serve to store therein anion concentrate, or cation concentrate for a predetermined time, and, then, discharge the concentrate accordingly.

At this time, the concentrate capturing members 13a, 13b each may be formed in a space provided at the inner side between the cation permeable membrane 12 and the anion permeable membrane 11. Accordingly, the anions and cations having passed through the inner side anion permeable membrane 11 or the inner side cation permeable membrane 12 may be blocked by the outer side cation permeable membrane 12 or the outer side anion permeable membrane 11 thereby being gathered within the capturing members.

Also, each of the concentrate capturing members 13a, 13b is connected to, e.g., a discharging line 19, and the ions gathered in the capturing members may be discharged outwards in response to opening/closing of the valve 18 connected to the discharging line 19.

Particularly, the housing 10 is mounted therein with two electrodes 14 playing which are configured to attract ions contained in cooling water. More specifically, the electrodes 14 are each arrayed at the behind the concentrate capturing members 13a, 13b. In doing so, one of the electrodes 14 is configured as a positive electrode and one of the electrodes 14 is configured as a negative electrode, both of which are connected to the controller 15 which is supplied with electric power.

Accordingly, if a DC power supply is applied to the electrode 14, anions are attracted to the positive electrode and cations are attracted to the negative electrode by electric force, thereby the ions pass through the selectively permeable membranes to be gathered within the concentrate capturing members 13a, 13b accordingly.

Accordingly, the operation of the apparatus for removing ions contained in cooling water will now be explained.

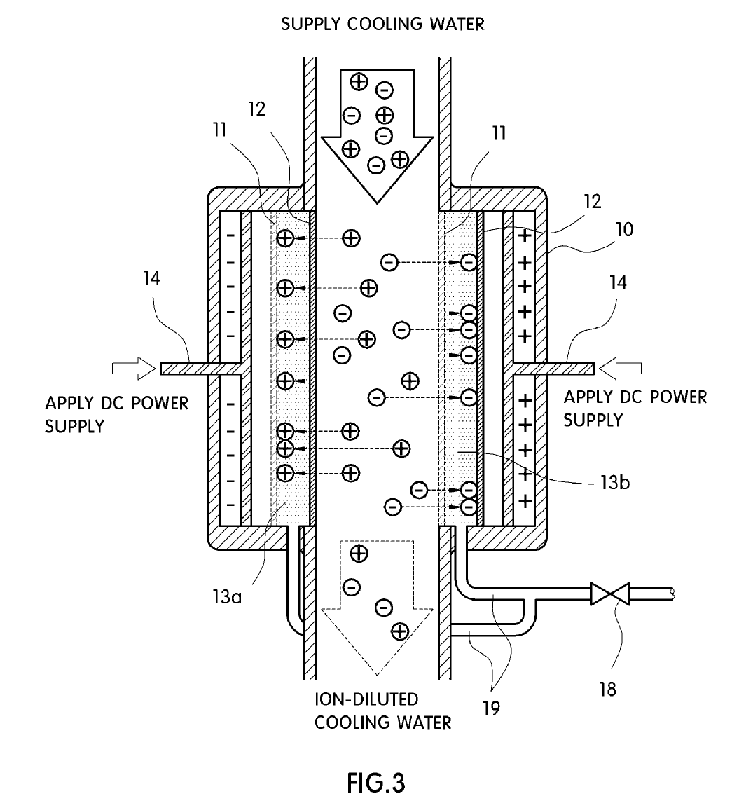

FIG. 3 is a cross sectional view showing an operation state of an electrodialysis type ion removing apparatus associated with the apparatus for removing ions contained in cooling water for a fuel cell vehicle according to an exemplary embodiment of the present invention.

As shown in FIG. 3, the apparatus for removing ions in cooling water is an electrodialysis type ion removing apparatus, and includes at least two or more electrodes, a plurality of anion exchange membranes, a plurality of cation exchange membranes, a housing means for inflow and discharge of cooling water, and concentrate capturing members for capturing anions and cations, respectively.

Accordingly, when a DC power supply is applied to the electrode 14 in the housing 10, anions in the cooling water flowing through the channel are attracted to a positive electrode and cations in the cooling water flowing through the channel are attracted to a negative electrode, respectively, by the electric force, and accordingly the ions pass through the ion exchange membranes thereby being gathered in the concentrate capturing members 13a, 13b.

As a result, the cooling fluid, e.g., water (hereinafter referred to as “cooling water”) has fewer ions when it leaves the housing 10 and thus has a lower electrical conductivity and in some cases has no electrical conductivity at all. Therefore, generated electricity is prevented from flowing through the cooling water and thus, being lost to the system.

In addition, as an electrical conductivity of cooling water is lowered, there is no need to additionally monitor the electrical conductivity of cooling water because doing so would be a waste of resources. Particularly, the magnitude of electric force causing ions to be attracted to the electrodes 14 may vary based on the amount of voltage supplied, and the magnitude of the supplied voltage may be determined on values predetermined according to the electrical conductivity measured by an electrical conductivity sensor 17.

However, when the electric power supplied to the electrodes 14 is cut off, the ions of concentrate again flow to the cooling water thereby again increasing the electrical conductivity of the cooling water. For example, the magnitude of the supplied voltage may be controlled in response to the electrical conductivity being measured by the electrical conductivity sensor 17. In this regard, in a case where the electrical conductivity of cooling water is below a predetermined value, voltage may not be supplied to the electrodes. In contrast, in a case where the electrical conductivity of cooling water is greater than a predetermined value, a voltage may be supplied to the electrodes to lower the electrical conductivity to a level that is below a predetermined value.

Also, in the case where the electrical conductivity of cooling water is greater than a predetermined value, the concentrate in the concentrate capturing members 13a, 13b may be discharged by controlling the valves, and, at the same time, the amount of discharged concentrate may be replaced with cooling water stored in the reservoir.

And, in a case where a predetermined or more voltage is applied, ions in cooling water are continuously attracted to the electrodes 14, and the electrical conductivity of cooling water is not reduced, the concentrate may be continuously discharged and the amount of discharged cooling water may be replaced with the cooling water stored in the reservoir.

Furthermore during manufacturing a vehicle, each component of vehicles is cleaned and the electrical conductivity of cooling water injected into the system is fairly low. However, as the water is circulated through the system over time, the conductivity of the cooling water increases accordingly, and therefore the required conductivity may not be reached even when the magnitude of voltage supplied to the electrodes is increased to a maximum value.

In this case, it is preferred that after the voltage is increased, the cooling water is cycled in such a manner that the cooling water that has an excess number of ions is discharged to the concentrate capturing member and the amount of discharged cooling water is displaced with a new cooling water having a lower electrical conductivity from the reservoir, or the entire cooling water is replaced with new cooling water accordingly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for removing ions contained in cooling water of a fuel cell vehicle comprising:
a housing mounted on a cooling water flowing line of a fuel cell stack to form a channel through which cooling water passes;
a plurality of anion permeable membranes and cation permeable membranes, each being respectively mounted on both sides of cooling water channel formed in the housing to allow cations and anions contained in cooling water selectively to pass through;
concentrate capturing members respectively disposed at each rear side of the anion permeable membrane and the cation permeable membrane to capture anions and cations having passed through the permeable membranes;
at least two or more electrodes disposed at each rear side of the concentrate capturing members to attract anions and cations contained in cooling water, respectively;
a controller for controlling the electrodes; and
a power source for applying electric power.

2. The apparatus for removing ions contained in cooling water for a fuel cell vehicle according to claim 1, further comprising an electrical conductivity sensor mounted a cooling water flowing line of the housing to measure an electrical conductivity of cooling water.

3. The apparatus for removing ions contained in cooling water for a fuel cell vehicle according to claim 1, wherein the concentrate capturing members are connected to a discharge line mounted therein with valves, for the discharge of the concentrate.

4. The apparatus for removing ions contained in cooling water for a fuel cell vehicle according to claim 2, wherein, when the electrical conductivity of cooling water is greater than a predetermined value, the concentrate of the concentrate capturing members is discharged and the amount of discharged cooling water is replaced with cooling water stored in a reservoir.

5. The apparatus for removing ions contained in cooling water for a fuel cell vehicle according to claim 2, wherein the magnitude of voltage applied to the electrodes is controlled in response to an electrical conductivity being measured by the electrical conductivity sensor.

6. The apparatus for removing ions contained in cooling water for a fuel cell vehicle according to claim 5, wherein, in a case where the electrical conductivity of cooling water is not decreased even when a voltage higher than a predetermined value is applied to the electrodes, the concentrate in the concentrate capturing members is discharged and the amount of discharged cooling water is replaced with cooling water stored in a reservoir.

7. An apparatus for removing ions contained in cooling fluid of a fuel cell vehicle comprising:
a housing mounted line containing cooling fluid of a fuel cell stack to form a channel through which cooling fluid passes;
a plurality of anion permeable membranes and cation permeable membranes, each being respectively mounted on both sides the channel formed in the housing to allow cations and anions contained in cooling fluid to selectively pass through each respectively;
concentrate capturing members respectively disposed between the anion permeable membrane and the cation permeable membrane on each side of the housing to capture anions and cations having passed through the permeable membranes respectively; and
at least two or more electrodes disposed behind the concentrate capturing members to attract anions and cations contained in cooling fluid, respectively, wherein the electrodes are supplied power via a power source.

8. The apparatus according to claim 7, further comprising wherein the cooling fluid is cooling water and an electrical conductivity sensor is mounted in the cooling water line to measure an electrical conductivity of cooling water as it is leaves the housing.

9. The apparatus according to claim 7, wherein the concentrate capturing members are connected to a discharge line mounted therein with valves, for the discharge of the concentrate accordingly.

10. The apparatus according to claim 8, wherein when the electrical conductivity of cooling water is greater than a predetermined value, the concentrate of the concentrate capturing members is discharged and the amount of discharged cooling water is replaced with cooling water stored in a reservoir.

11. The apparatus according to claim 8, wherein the magnitude of voltage applied to the electrodes is controlled in response to an electrical conductivity being measured by the electrical conductivity sensor.

12. The apparatus according to claim 11, wherein, in a case where the electrical conductivity of cooling water is not decreased even when a voltage higher than a predetermined value is applied to the electrodes, the concentrate in the concentrate capturing members is discharged and the amount of discharged cooling water is replaced with cooling water stored in a reservoir.

13. The apparatus of claim 7 wherein the apparatus further comprises a controller to control the at least two or more electrodes.
